(19) United States
(12) Patent Application Publication
(10) Pub. No.: US 2013/0172792 A1
(43) Pub. Date: Jul. 4, 2013

(54) MASSAGING CHAIR WITH PALM MASSAGING DEVICES

(71) Applicant: Chih-Hua Tao, Kaohsiung (TW)

(72) Inventor: Chih-Hua Tao, Kaohsiung (TW)

(73) Assignee: CHE TAI INTERNATIONAL CO., LTD., Kaohsiung (TW)

(21) Appl. No.: 13/342,975

(22) Filed: Jan. 4, 2012

(51) Int. Cl. A61H 15/00

(52) U.S. Cl. 601/116

(57) ABSTRACT

A massaging chair is provided with a base; a seat supported by the base; two arms on both sides of the seat respectively; a back pivotably secured to the base; and two palm massaging devices each including a sliding assembly slidably disposed on the arm, and a massaging assembly on the sliding assembly. The massaging assembly includes a casing, at least one first air cushion on an underside of a top of the casing, and at least one second air cushion on a bottom of an interior of the casing, each of the at least one second air cushions having massaging knobs. The sliding assembly includes two parallel rails, a support between the rails, two first rollers each rotatable in one rail and connecting to the support, two second rollers each rotatable in the other rail and connecting to the support, and a seat held by the support and connecting to the massaging assembly.

### BACKGROUND OF THE INVENTION

1. Field of the Invention

The invention relates to massaging chairs and more particularly to a massaging chair having two devices each adjacent to the arm for massaging a hand, and especially the palm.

2. Description of the Related Art

A conventional massaging chair 2 is shown in FIGS. 1 and 2 and comprises two arms 21 on both sides of the chair, respectively, a seat 22, a pivoting back 23, two triangular pivoting arms 24, and two abutting members 25 on both sides of the back 23, respectively. One end of each arm 24 is urged against the respective abutting member 25.

In use, a person may rest their hands on the arms 24 and then activate a motor (not shown) to move each of the abutting members 25 back and forth along a groove on either side of the back 23 with the back 23 pivoting cyclically. As a result, the arms 24 can bring a massaging effect to the hands.

However, the conventional massaging chair 2 does not take different individuals with different hand lengths into consideration. Thus, the desired massaging effect is compromised for some people having longer or shorter hand lengths. Further, the massaging effect to the palm and fingers is not sufficient. Thus, the need for improvement still exists.

### SUMMARY OF THE INVENTION

It is therefore one object of the invention to provide a massaging chair comprising a base; a seat supported by the base; two arms on both sides of the seat respectively; a back pivotably secured to the base; and two palm massaging devices each comprising a sliding assembly slidably disposed on the arm, and a massaging assembly disposed on the sliding assembly, wherein the massaging assembly includes a casing, at least one first air cushion on an underside of a top of the casing, and at least one second air cushion on a bottom of an interior of the casing, each of the at least one second air cushions having a plurality of massaging knobs; and wherein the sliding assembly includes two parallel rails, a support between the rails, two first rollers each rotatably disposed in one rail and connecting to the support, two second rollers each rotatably disposed in the other rail and connecting to the support, and a seat held by the support and connecting to the massaging assembly.

The above and other objects, features and advantages of the invention will become apparent from the following detailed description taken with the accompanying drawings.

### BRIEF DESCRIPTION OF THE DRAWINGS

FIG. 1 is a side elevational view of a conventional massaging chair;

FIG. 2 is a view similar to FIG. 1 showing a massaging chair in a massaging operation;

FIG. 3 is a side elevational view of a massaging chair according to an embodiment of the invention;

FIG. 4 is a side elevational of an air cushion;

FIG. 5 is a perspective view of a roller assembly;

FIG. 6 is a perspective view illustrating mounting of the roller assembly in the air cushion;

FIG. 7 is a perspective view of a first preferred embodiment of a sliding assembly according to the invention;

FIG. 8 is a side elevational of a second preferred embodiment of a sliding assembly according to the invention;

FIG. 9 is a longitudinal sectional view of a third preferred embodiment of a sliding assembly according to the invention; and

FIG. 10 is a schematic top view of a fourth preferred embodiment of a sliding assembly according to the invention.

### DETAILED DESCRIPTION OF THE INVENTION

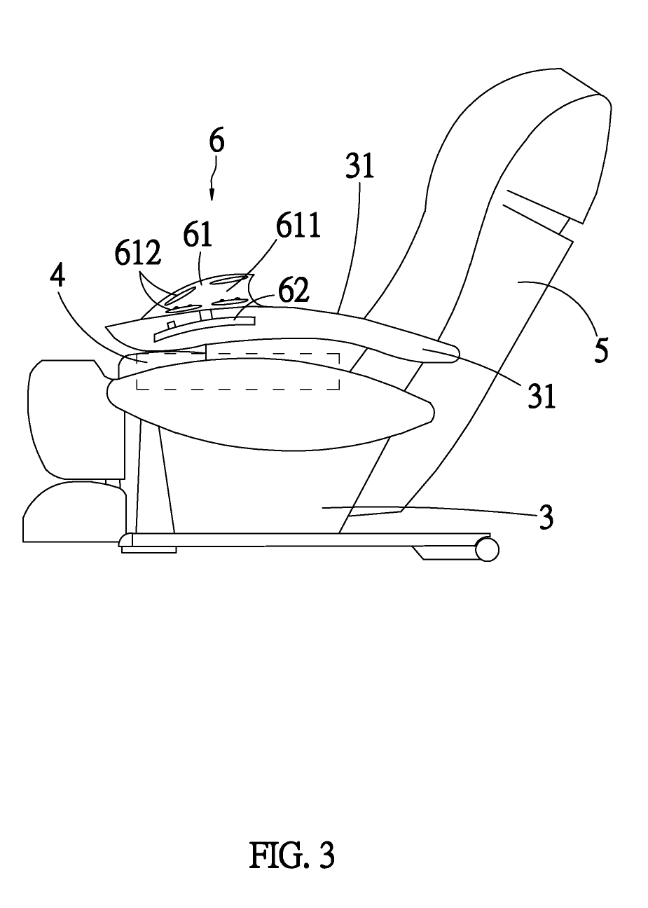

Referring to FIG. 3, a massaging chair in accordance with the invention is in the form of recliner and comprises a base 3 resting upon the ground, a seat 4, two arms 31 extending upward from both sides of the seat 4 respectively, a back 5, and two palm massaging devices 6. Each of the above components will be discussed in detail below.

The seat 4 is supported by the base 3. The back 5 is pivotably secured to the base 3. Each palm massaging device 6 comprises a massaging assembly 61 and a sliding assembly 62. The massaging assembly 61 is provided on the sliding assembly 62 and comprises a casing 611 and a plurality of (e.g., four) air cushions 612 in the casing 611. Each sliding assembly 62 is provided an a respective arm 31 and is adapted to slide about the arm 31.

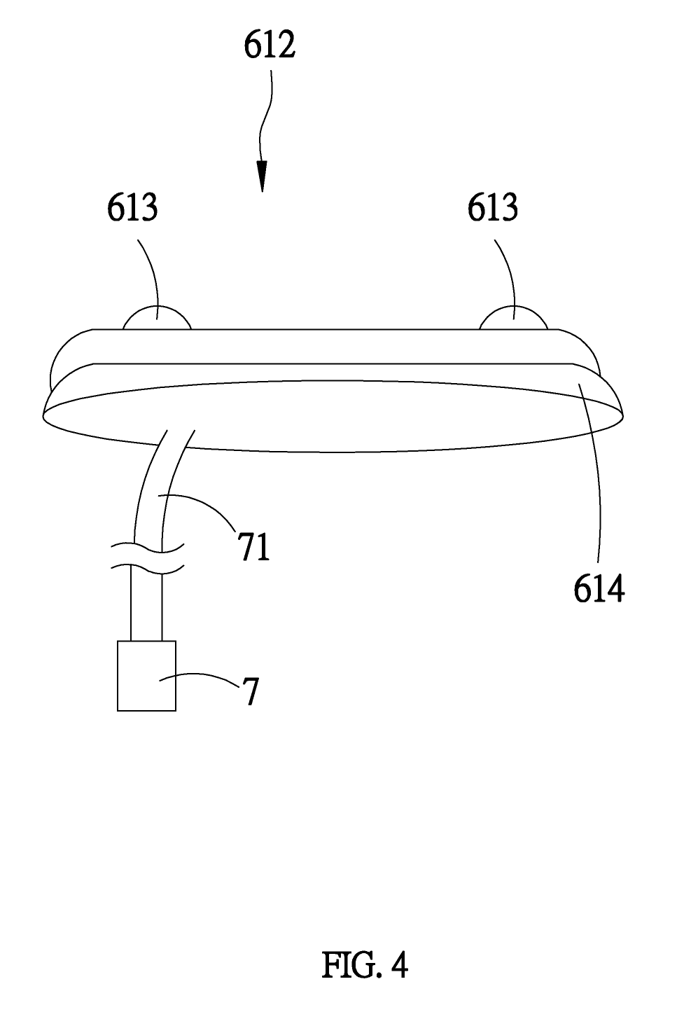

Referring to FIGS. 3 and 4, each air cushion 612 can be inflated by supplying compressed air from a compressor 7 via a flexible tube 71. Two of the four air cushions (i.e., upper air cushions) 612 are provided on the underside of a top of the casing 611 for massaging the back of the palm. The other two air cushions (i.e., lower air cushions) 612 are provided on the bottom of the interior of the casing 611 and each comprise a plurality of massaging knobs 613 on a top surface thereof for providing a massaging effect on the palm. A heating element 614 is provided on a bottom of the four air cushions 612. The heating element 614 can be activated to warm the palm by electrically connecting to an external power source (not shown).

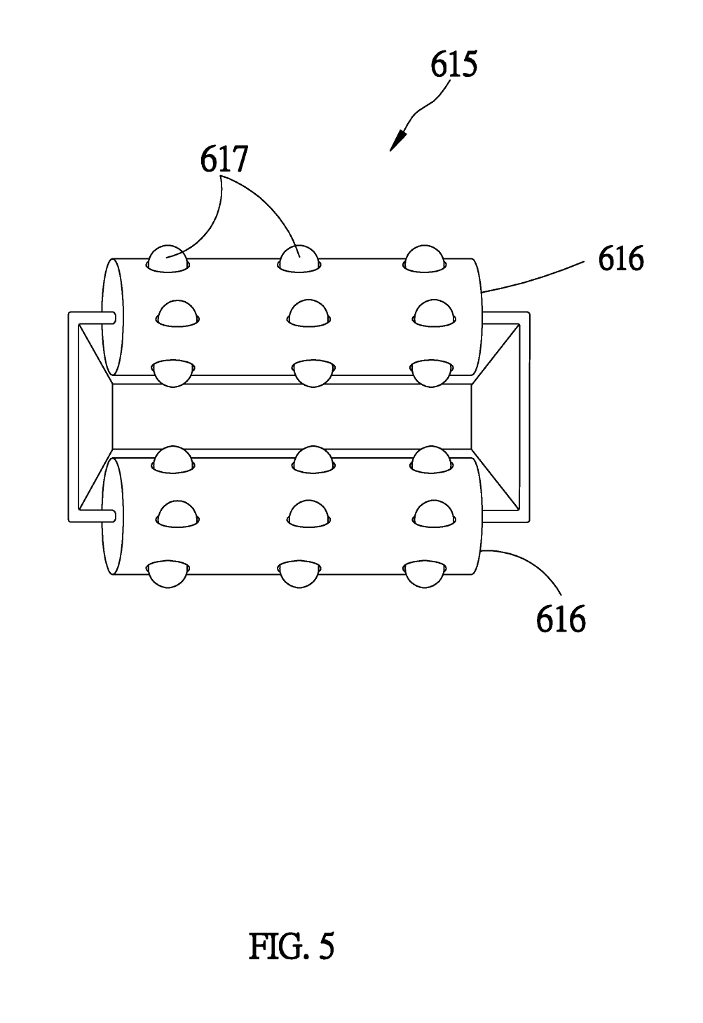

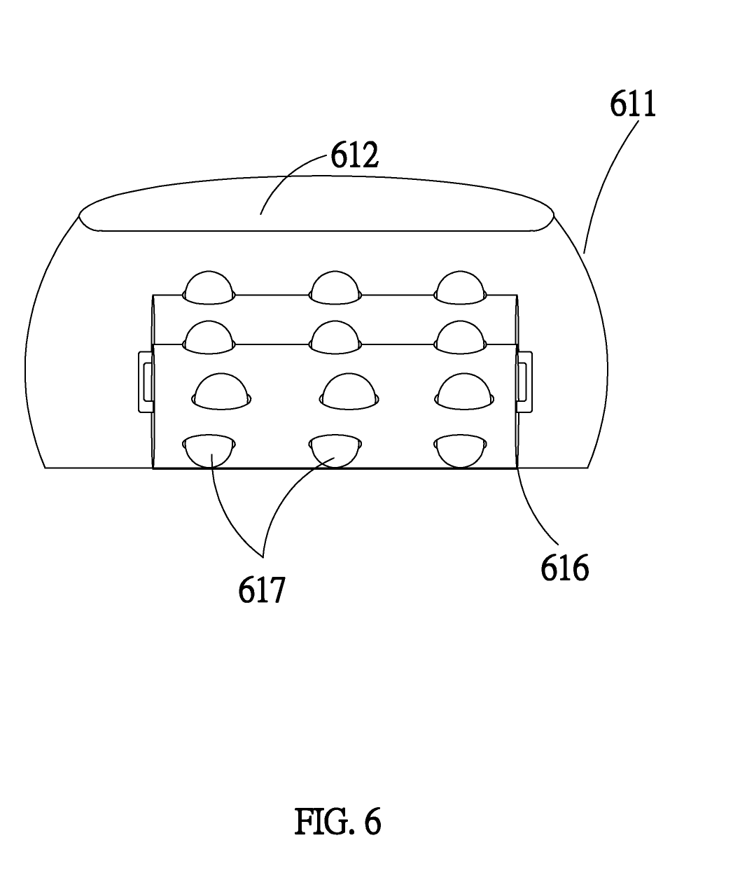

As shown in FIGS. 5 and 6, a roller assembly 615 is additionally provided in the casing 611 and comprises two parallel elongated rollers 616 each being rotatable about its transverse axis and including a plurality of freely rotating balls 617 partially projecting out of its cylindrical surface for providing a massaging effect to the palm (i.e., the palm) touching thereon. Each roller 616 is powered by an AC (alternating current) motor (not shown) provided therein.

The roller assembly 615 can be installed in the casing 611 by first deflating the two lower air cushions 612 and next inserting the roller assembly 615 into the casing 611.

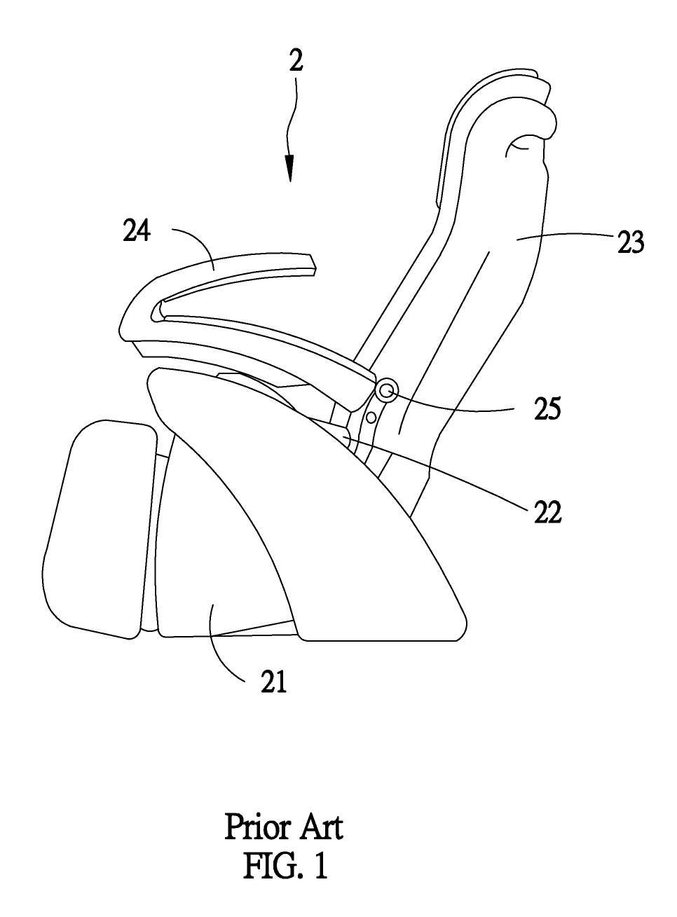

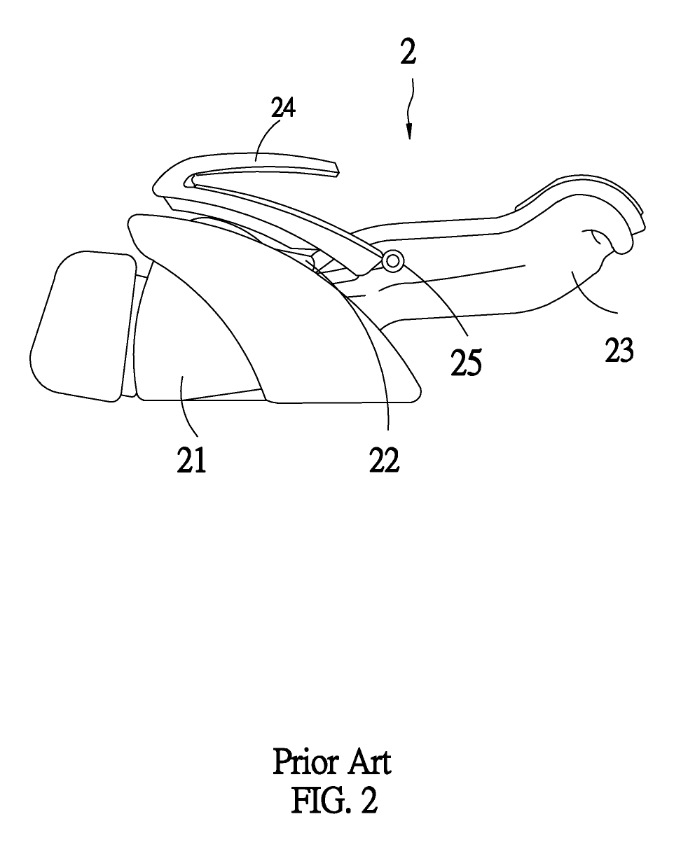

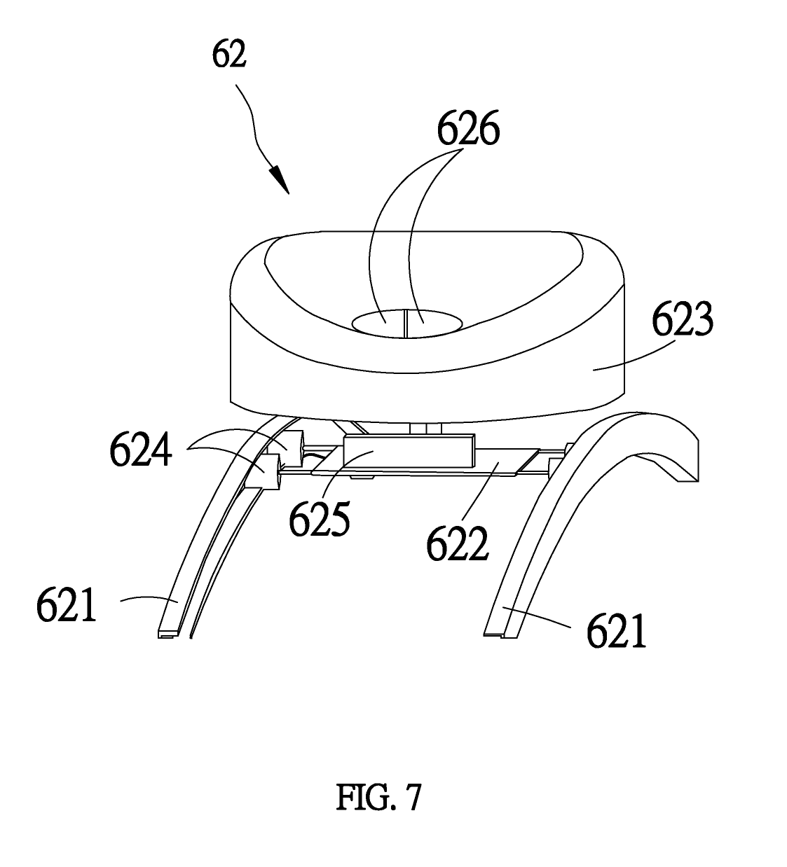

As shown in FIG. 7 in conjunction with FIGS. 1 and 2, the sliding assembly 62 according to a first preferred embodiment of the invention comprises two parallel curved rails 621; a rectangular support 622 between the rails 621; four rollers 624 each rotatably disposed on an end of an axis extending from one of four corners of the support 622 and rotatably disposed in the rail 621 in which two rollers 624 are grouped as one set and the other two rollers 624 are grouped as the other set; an AC motor 625 mounted on the support 622, a seat member 623 disposed above the AC motor 625, and a forward/backward button 626 on a top of the seat member 623.

In use, a person lying on the back 5 may first turn on the button 626 to activate the AC motor 625 which in turn slowly moves the rollers 624 either forward or backward along the rails 621. Thus, it is possible to adjust the position of the sliding assembly 62 on the arm 31. This enables the palm massaging device 6 to fit different individuals with various hand lengths. Next, the person may insert his or her hands into the casings 611. Finally, the person may turn on an on/off switch (not shown) to activate the rollers 616 to massage the palms.

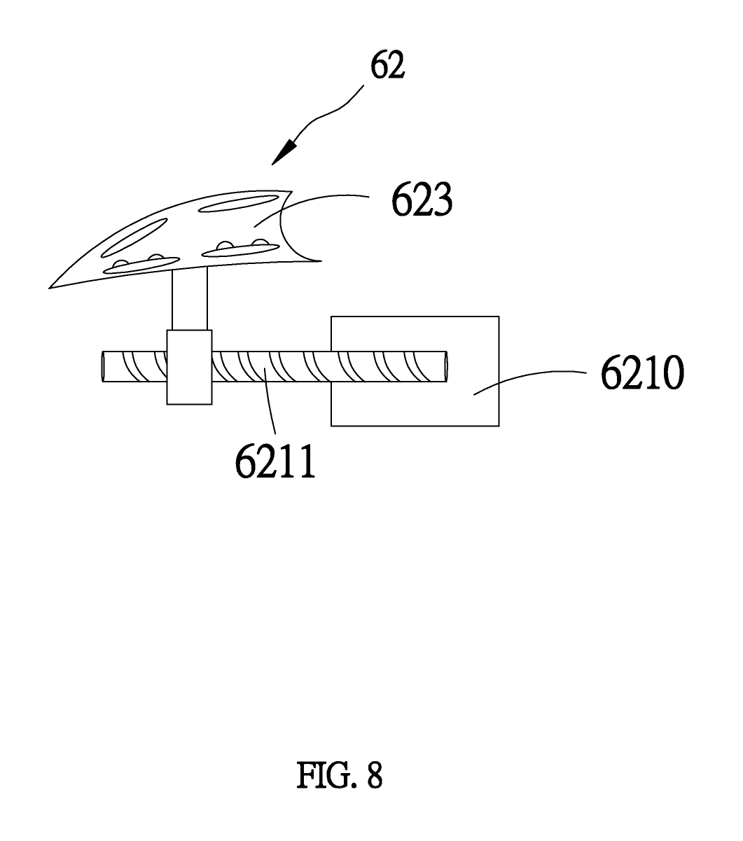

Referring to FIG. 8 in conjunction with FIG. 1, a second preferred embodiment of the sliding assembly 62 of the invention is shown. The characteristics of the second preferred embodiment are detailed below. An AC motor 6210 is provided in one of the arms 31. A threaded drive shaft 6211 extends from the AC motor 6210. The seat member 623 has a leg (not numbered) threadedly engaged with the drive shaft 6211 so that in response to activating the AC motor 6210 a clockwise or counterclockwise rotation of the drive shaft 6211 can move the seat member 623 forward or backward. As a result, the object of adjusting position of the sliding assembly 62 is obtained.

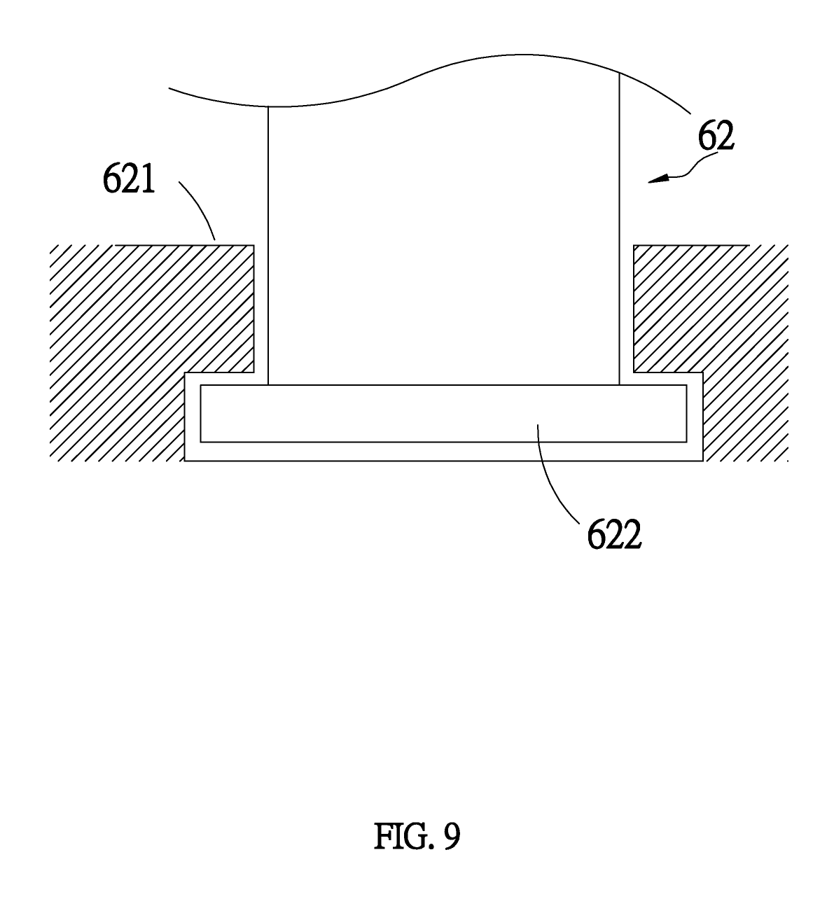

Referring to FIG. 9 in conjunction with FIG. 1, a third preferred embodiment of the sliding assembly 62 of the invention is shown. The characteristics of the third preferred embodiment are detailed below. A grooved rail 621 having an inverted T-shaped longitudinal section is provided on the arm 31 and a support 622 having an inverted T-shaped longitudinal section is disposed in the rail 621 to form a mating joined relationship. The support 622 can move along the rail 621 for adjusting the position of the sliding assembly 62.

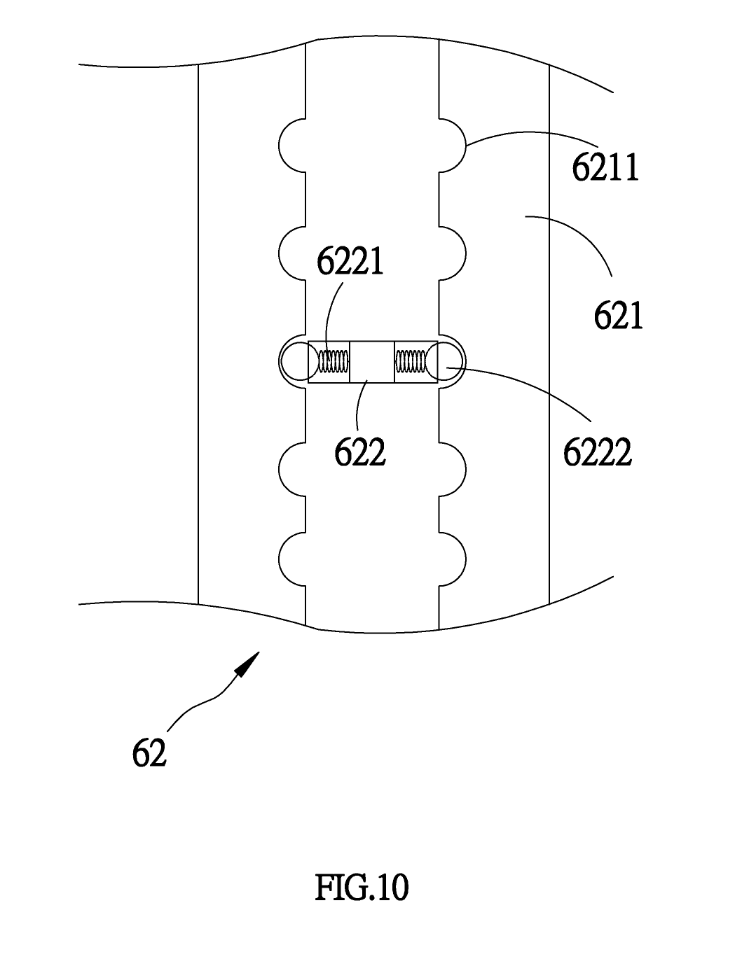

Referring to FIG. 10 in conjunction with FIG. 1, a fourth preferred embodiment of the sliding assembly 62 of the invention is shown. The characteristics of the fourth preferred embodiment are detailed below. The rail 621 comprises a plurality of equally spaced-apart semi-spherical holes 6211 along an inner side facing each other. The support 622 is implemented as a spring depressible member having two helical springs 6221 therein and two balls 6222 at both ends respectively. Each ball 6222 partially projects out from either end of the support 622 to be retained in a corresponding hole 6211 due to the expansion of the spring 6221. A manual pushing of the support 622 can move the support 622 positioned at one of the holes 6211 to another of the holes 6211. As a result, the objective of adjusting the position of the sliding assembly 62 is obtained.

While the invention has been described in terms of preferred embodiments, those skilled in the art will recognize that the invention can be practiced with modifications within the spirit and scope of the appended claims.

What is claimed is:

1. A massaging chair with palm massaging devices comprising:
a base;
a seat supported by the base;
two arms on respective sides of the seat;
a back pivotably secured to the base; and
two palm massaging devices each comprising a sliding assembly slidably disposed on a respective arm, and a massaging assembly disposed on each sliding assembly,
wherein the massaging assembly includes a casing, at least one first air cushion on an underside of a top of the casing, and at least one second air cushion on a bottom of an interior of the casing, each of the at least one second air cushions having a plurality of massaging knobs; and
wherein the sliding assembly includes two parallel rails, a support between the rails, two first rollers each rotatably disposed in one rail and connecting to the support, two second rollers each rotatably disposed in the other rail and connecting to the support, and a seat held by the support and connecting to the massaging assembly.

2. The massaging chair with palm massaging devices of claim 1, further comprising a heating element on a bottom of the casing.

3. The massaging chair with palm massaging devices of claim 1, further comprising a roller assembly in each casing, the roller assembly including two parallel elongated rollers each being rotatable about its transverse axis and including a plurality of freely rotating balls partially projecting out from its cylindrical surface.

4. A massaging chair with palm massaging devices comprising:
a base;
a seat supported by the base;
two arms on respective sides of the seat;
a back pivotably secured to the base; and
two palm massaging devices each comprising a sliding assembly slidably disposed on a respective arm, and a massaging assembly disposed on each sliding assembly,
wherein the massaging assembly includes a casing, at least one first air cushion on an underside of a top of the casing, and at least one second air cushion on a bottom of an interior of the casing, each of the at least one second air cushions having a plurality of massaging knobs; and
wherein the sliding assembly includes two parallel rails each having a plurality of equally spaced apart semi-spherical holes along an inner side facing the other rail, an elongated support between the rails and having two internal biasing members and two balls at both ends respectively, each ball being held in a hole by the respective biasing member, and a seat held by the support and connecting to the massaging assembly.

5. The massaging chair with palm massaging devices of claim 4, further comprising a heating element on a bottom of the casing.

6. The massaging chair with palm massaging devices of claim 4, further comprising a roller assembly in the casing, the roller assembly including two parallel elongated rollers each being rotatable about its transverse axis and including a plurality of freely rotating balls partially projecting out from of its cylindrical surface.
